(19) United States
(12) Patent Application Publication
(10) Pub. No.: US 2024/0000186 A1
(43) Pub. Date: Jan. 4, 2024

(54) SOLE AND SHOE

(71) Applicant: ASICS CORPORATION, Kobe-shi (JP)

(72) Inventors: Yoshikazu MITSUHATA, Kobe-shi (JP); Yoshihiro EGUCHI, Kobe-shi (JP)

(21) Appl. No.: 17/854,546

(22) Filed: Jun. 30, 2022

(51) Int. Cl. A43B 13/18

(52) U.S. Cl. CPC A43B 13/184; A43B 13/186

(57) ABSTRACT

A sole includes a midsole and an outsole. The midsole includes a midsole body and a plate. The plate includes an MP portion through hole and a rear edge having a shape extending gradually frontward in the foot length direction, toward a medial foot side. The midsole body includes a reinforced region overlapping the plate in the thickness direction and being reinforced by the plate, and a non-overlapping region that is formed to be located adjacent to at least one of a medial foot side and a lateral foot side of the reinforced region in the foot width direction, and does not overlap the plate in the thickness direction.

### BACKGROUND

### Field of the Invention

The present disclosure relates to a sole and a shoe.

### Background Information

During running on a rough ground such as trail running, a thrust force may be applied to the shoe when making contact with the ground. In order to prevent this thrust force from being transferred to the foot, the shoe may be provided with a plate. For example, Japanese Patent Publication No. 2010-527654 discloses an article of footwear including an outsole, a midsole, and a plate insert disposed between the outsole and the midsole. The plate insert is disposed to extend over the entire region in the foot width direction.

### SUMMARY

It has been determined that the sole as disclosed in Japanese Patent Publication No. 2010-527654 restricts motion of the foot in the ground contact phase and the take-off phase, and also increases the impact applied to the foot in the ground contact phase and the take-off phase.

An object of the present disclosure is to provide a sole and a shoe that can alleviate restrictions on foot motion and alleviate impact applied to the foot, in at least one of the ground contact phase and the take-off phase.

A sole according to an aspect of the present disclosure is a sole forming a part of a shoe. The sole includes: a midsole; and an outsole connected to a lower surface of the midsole and forming a ground contact surface. The midsole includes: a midsole body including a forefoot region overlapping, in a thickness direction of the sole, a forefoot portion of a wearer of the shoe, a midfoot region overlapping, in the thickness direction, a midfoot portion of the wearer, and a rearfoot region overlapping, in the thickness direction, a rearfoot portion of the wearer; and a plate made from a material having a hardness higher than a hardness of the midsole body, and fixed to the midsole body to overlap, in the thickness direction, MP joints of a foot of the wearer and extend on the forefoot region and the midfoot region. The plate includes: an MP portion through hole extending, in the thickness direction, through a region including at least a part of a portion overlapping, in the thickness direction. MP joints of the foot of the wearer; and a rear edge formed at a rear end in a foot length direction of the shoe, and having a shape extending gradually frontward in the foot length direction, toward a medial foot side in a foot width direction of the shoe. The midsole body includes: a reinforced region overlapping the plate in the thickness direction and being reinforced by the plate- and a non-overlapping region that is formed to be located adjacent to at least one of a medial foot side and a lateral foot side of the reinforced region in the foot width direction, and does not overlap the plate in the thickness direction.

A shoe according to an aspect of the present disclosure includes the sole and an upper portion connected to the sole and forming, together with the sole, a space for receiving the foot of the wearer.

According to the present disclosure, a sole and a shoe can be provided that enable alleviation of restrictions on foot motion and alleviation of impact applied to the foot, in at least one of the ground contact phase and the take-off phase.

### BRIEF DESCRIPTION OF THE DRAWINGS

Embodiments of the invention will be explained in more detail hereinafter with reference to the drawings.

FIG. 1 is a cross-sectional view schematically showing a shoe according to one embodiment of the present disclosure.

FIG. 2 is a plan view of a sole.

FIG. 3 is an enlarged view of the sole as seen in plan view.

FIG. 4 is a plan view of a plate.

FIG. 5 is a bottom view of a midsole.

FIG. 6 is a bottom view of a midsole body 110 showing a reinforced region and a non-overlapping region.

FIG. 7 is a bottom view of an outsole.

FIG. 8 is a cross-sectional view along a line VIII-VIII in FIG. 7.

FIG. 9 shows a modification of the plate.

FIG. 10 shows a modification of the plate.

FIG. 11 shows a modification of the plate.

FIG. 12 shows a modification of the plate.

FIG. 13 shows a modification of the plate.

### DETAILED DESCRIPTION

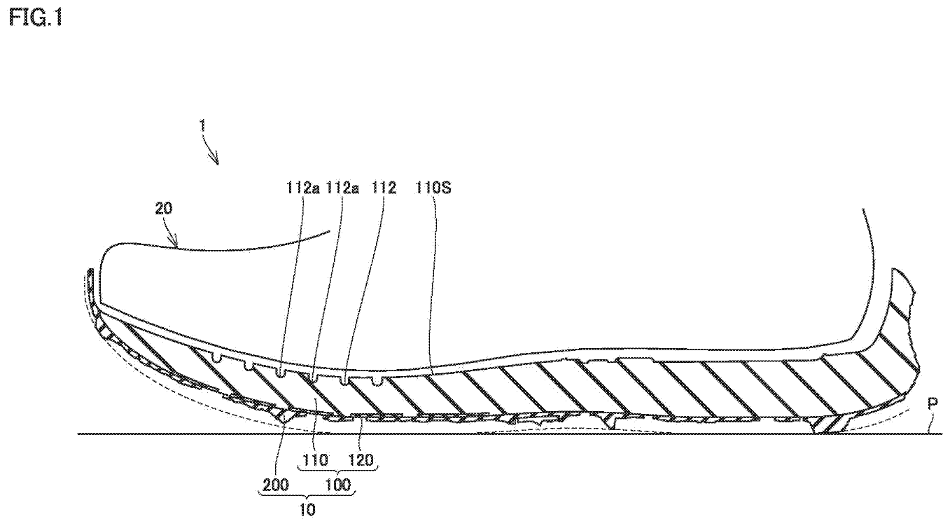

Embodiments of the present disclosure are described with reference to the drawings. In the drawings referenced below, the same or corresponding parts are denoted by the same reference numerals. In the following description, terms such as foot length direction, foot width direction, frontward, rearward are used. Each of these terms representing a direction indicates the direction as seen from a viewpoint of a wearer of a shoe 1 placed on a flat plane P (see FIG. 1) such as ground. For example, frontward refers to toward the toe and rearward refers to toward the heel. Moreover, inner side or medial foot side refers to the first-toe side of the foot in the foot width direction, and outer side or lateral foot side refers to the fifth-toe side of the foot in the foot width direction.

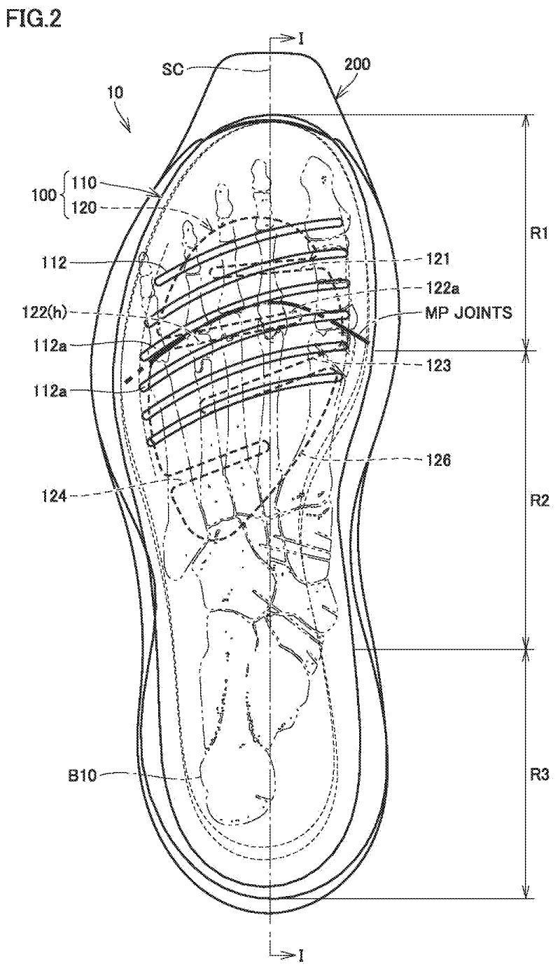

FIG. 1 is a cross-sectional view schematically showing a shoe according to one embodiment of the present disclosure. FIG. 2 is a plan view of a sole. While FIG. 2 shows a sole 10 for the left foot, this sole 10 is also applicable to the right foot. In this case, the sole for the right foot is formed in a shape in bilateral symmetry with the sole for the left foot, or a shape nearly identical thereto. The shoe 1 according to the present embodiment is suitable for use as a shoe for running on a rough ground such as trail running or a shoe for climbing, for example. The use of the shoe 1, however, is not limited to them.

As shown in FIG. 1, the shoe 1 includes the sole 10 and an upper portion 20.

The upper portion 20 is connected to the sole 10. The upper portion 20 and the sole 10 together form a space for receiving afoot of a wearer. The upper portion 20 covers the upper surface of the foot of the wearer. An inner sole (not shown) may be connected to a lower part of the upper portion 20.

The sole 10 forms a part of the shoe 1. The sole 10 is connected to a lower part of the upper portion 20. As shown in FIGS. 1 and 2, the sole 10 includes a midsole 100 and an outsole 200.

The midsole 100 is placed over the outsole 200. The upper portion 20 is placed over the midsole 100. Namely, the midsole 100 is located between the upper portion 20 and the outsole 200.

The midsole 100 includes a midsole body 110 and a plate 120.

The midsole body 110 has a cushioning function and the like exhibited in the ground contact phase. Preferably, the midsole body 110 is formed from a resin or rubber material that is excellent in cushioning property while having an appropriate strength. The midsole body 110 is formed, for example, from a resin foam material including a resin material as a main component and a foaming agent and a crosslinking agent as auxiliary components. In the present embodiment, the midsole body 110 is made from EVA. The midsole body 110 has a hardness of HC 40 or more and HC 50 or less, for example.

As shown in FIG. 2, the midsole body 110 includes a forefoot region R1, a midfoot region R2, and a rearfoot region R3.

The forefoot region R1 is a region overlapping, in the thickness direction of the sole 10, the forefoot portion of a wearer of the shoe 1. The forefoot portion is a part of the foot of the wearer that is located frontward in the longitudinal direction of the shoe 1, i.e., the foot length direction (top-to-bottom direction in FIG. 2) of the shoe 1. The forefoot region R1 is a region extending over a range from the front end of the shoe 1 to a first position shifted by a length of approximately 30% with respect to the total length of the shoe 1, from the front end toward the rear end along a shoe center SC (see FIG. 2).

The foot length direction is a direction parallel to the shoe center SC (see FIG. 2). The shoe center SC is not limited to the centerline of the shoe 1, but can be a line corresponding to a straight line connecting a heel bone B10 of a standard wearer of the shoe 1 and a point between the first toe and the second toe of the wearer.

The midfoot region R2 is a region overlapping, in the thickness direction, the midfoot portion of the wearer. The midfoot portion is a part of the foot of the wearer located centrally in the foot length direction. The midfoot region R2 is a region located to extend over a range from the first position to a second position shifted by a length of approximately 70% with respect to the total length of the shoe 1 along the shoe center SC, from the front end toward the rear end of the shoe 1.

The rearfoot region R3 is a region overlapping, in the thickness direction, the rearfoot portion of the wearer of the shoe 1. The rearfoot portion is a part of the foot of the wearer that is located rearward in the foot length direction. The rearfoot region R3 is a region located to extend over a range between the second position and the rear end of the shoe 1.

The midsole body 110 has a surface 110S. In this surface 110S, at least one groove 112 is formed. In the present embodiment, the at least one groove 112 includes six grooves 112. Each groove 112 is depressed from the surface 110S toward the outsole 200.

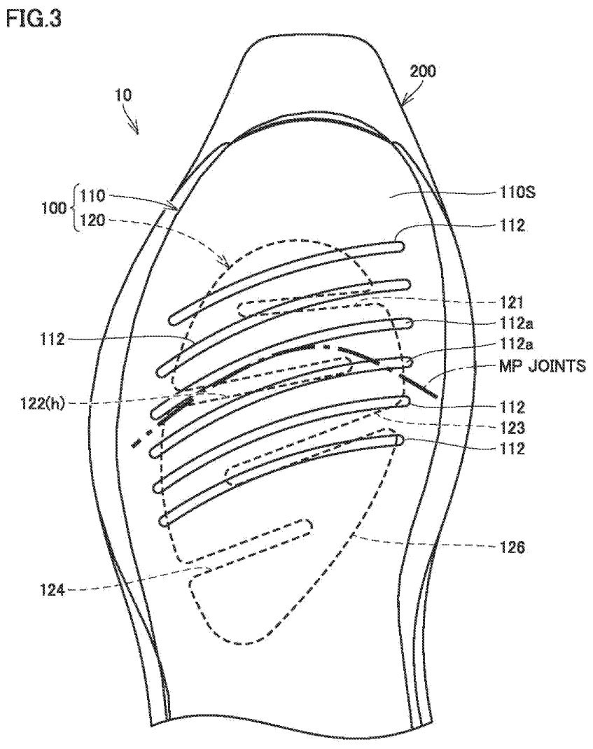

As shown in FIGS. 2 and 3, the groove 112 has a shape extending gradually rearward in the foot length direction, from the medial foot side toward the lateral foot side (left side in FIGS. 2 and 3) in the foot width direction. The length of the groove 112 can traverse the midsole surface, since the length of the groove 112 that is longer in the foot width direction promotes motion of the MP joints to a greater extent. In the present embodiment, the groove length is approximately identical to the foot width of a standard wearer. The groove 112 has a shape curved to project frontward in the foot length direction, as seen in plan view. Beside this, the groove 112 can have a wavy shape, a linear shape, or a shape made up of dots and lines.

The at least one groove 112 includes an MP portion overlapping groove 112a formed in a region including at least a part of the portion that overlaps the MP joints of the foot of the wearer in the thickness direction.

The plate 120 has a function of preventing a thrust force from a rough ground from being transferred to the foot in the ground contact phase. The plate 120 is made from a material having a higher hardness than the hardness of the midsole body 110. The hardness of the plate 120 is set for example to HA 80 or more and HA 95 or less.

The plate 120 is made from the same material as the material from which the midsole body 110 is made, i.e., made from EVA. The plate 120 can be formed from a material different from the material from which the midsole body 110 is made.

The plate 120 is fixed to the midsole body to overlap, in the thickness direction, the MP joints of the foot of the wearer, and extend on the forefoot region R1 and the midfoot region R2. The plate 120 is fixed to the bottom surface of the midsole body 110. The plate 120 is formed integrally with the midsole body 110. As shown in FIG. 1, the bottom surface of the plate 120 and the bottom surface of the midsole body 110 connect smoothly to each other without forming steps.

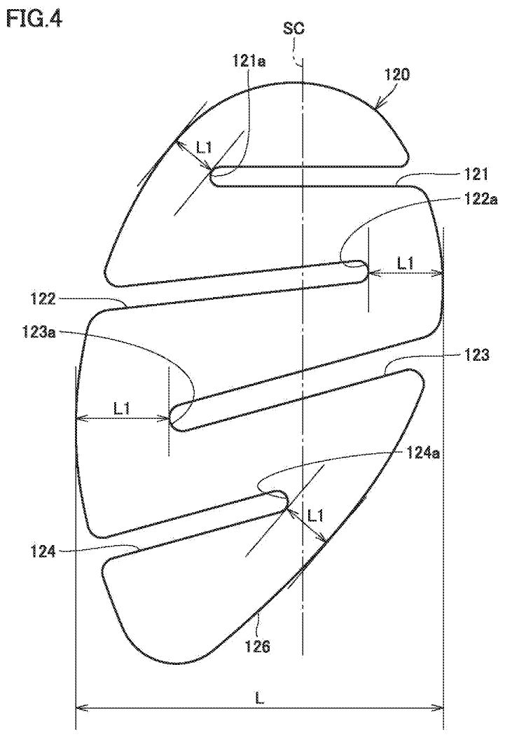

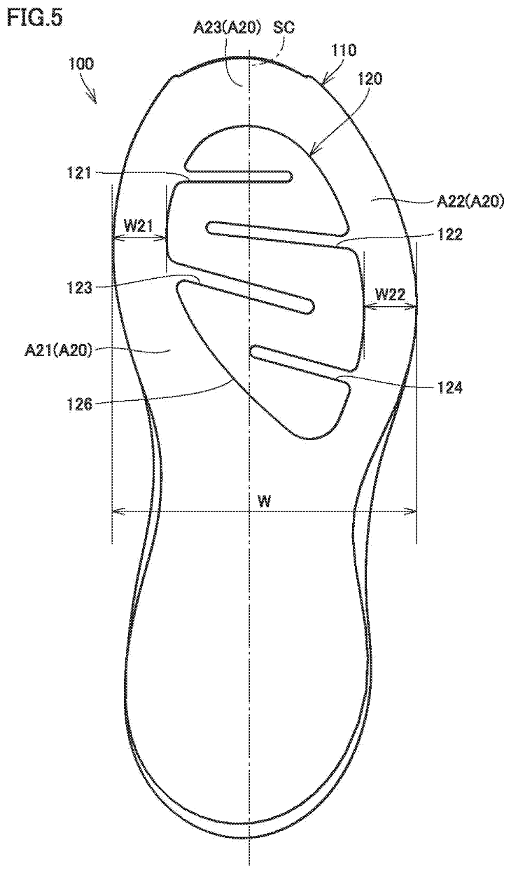

As shown in FIGS. 2 and 3, the plate 120 has an MP portion through hole h extending, in the thickness direction, through a region including at least a part of the part overlapping, in the thickness direction, the MP joints of the foot of the wearer. In the present embodiment, the plate 120 has a plurality of slits including the MP portion through hole h. As shown in FIGS. 2 to 5, a plurality of slits include four slits formed to be spaced away from each other in the foot length direction, i.e., a first slit 121, a second slit 122, a third slit 123, and a fourth slit 124. FIG. 4 is a plan view of the plate 120 for the left foot, and FIG. 5 is a bottom view of the midsole 100 for the left foot.

The first slit 121 is formed in a front portion of the plate 120. The first slit 121 is opened on the medial foot side in the foot width direction. As shown in FIG. 4, the first slit 121 has an outer edge 121a formed on the lateral foot side relative to the shoe center SC in the foot width direction.

The second slit 122 is formed in a portion located rearward of the first slit 121 in the plate 120. In the present embodiment, as shown in FIGS. 2 and 3, the second slit 122 forms the MP portion through hole h. The MP portion through hole h has a shape extending gradually rearward in the foot length direction, toward the lateral foot side in the foot width direction. The MP portion through hole h is opened on the lateral foot side in the foot width direction. As shown in FIGS. 2 and 3, a part of the MP portion through hole h overlaps, in the thickness direction, the MP portion overlapping groove 112a. In other words, the MP portion overlapping groove 112a crosses, in the thickness direction, the MP portion through hole h. The MP portion through hole h has an inner edge 122a formed on the medial foot side relative to the shoe center SC in the foot width direction.

The third slit 123 is formed in a portion located rearward of the second slit 122 in the plate 120. The third slit 123 is opened on the medial foot side in the foot width direction.

The third slit 123 has a shape extending gradually rearward in the foot length direction, toward the lateral foot side in the foot width direction. The third slit 123 has an outer edge 123a formed on the lateral foot side relative to the shoe center SC in the foot width direction.

The fourth slit 124 is formed in a portion located rearward of the third slit 123 in the plate 120. The fourth slit 124 is opened on the lateral foot side in the foot width direction. The fourth slit 124 has a shape extending gradually rearward in the foot length direction, toward the lateral foot side in the foot width direction. The fourth slit 124 has an inner edge 124a formed on the medial foot side in the foot width direction. The inner edge 124a can be formed inward relative to the shoe center SC, can be formed outward relative to the shoe center SC, or can be formed on the shoe center SC.

In the present embodiment, a plurality of slits including the MP portion through hole h each have a shape extending linearly continuously. Beside this, the slits can each have a wavy shape, a linear shape, a curved shape, a combination of dots and lines, or a discontinuously linear shape.

As shown in FIG. 4, a distance L1 between each of the edges 121a, 122a, 123a, and 124a, and an outer edge of the plate 120 is preferably set to approximately 5% to 30% of a maximum dimension L of the plate 120 in the foot width direction. The distance L1 refers to a minimum value of the length of a line segment connecting each of the edges 121a, 122a, 123a, and 124a, and a tangent on the outer edge of the plate 120.

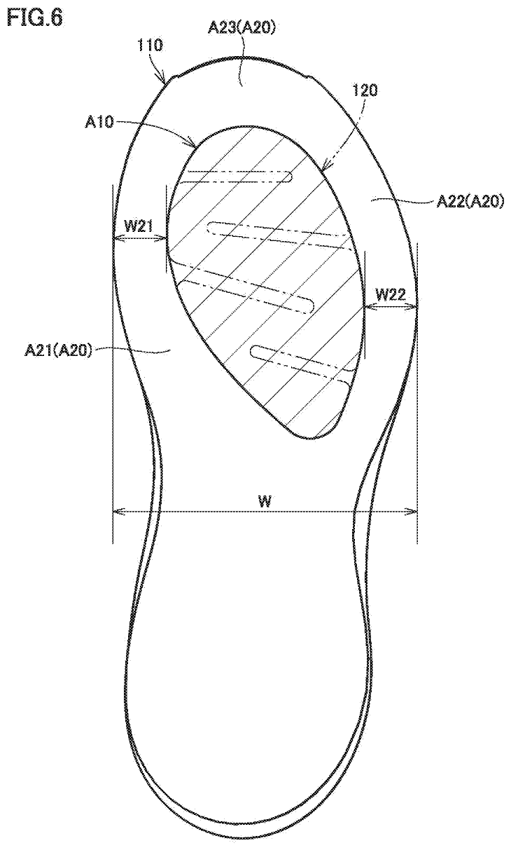

As shown in FIG. 5, the plate 120 is located in a central portion, in the foot width direction, of the midsole body 110. Accordingly, in the midsole body 110, a reinforced region A10 (see FIG. 6) and a non-overlapping region A20 are formed.

The reinforced region A10 overlaps the plate 120 in the thickness direction, and is a region reinforced by the plate 120. As shown in FIG. 6, the reinforced region A10 has a shape identical to the outline of the plate 120 without slits 121 to 124. In FIG. 6, oblique lines are drawn in the reinforced region A10.

The non-overlapping region A20 is a region that does not overlap the plate 120 in the thickness direction. The non-overlapping region A20 is formed to be located adjacent to the medial foot side and the lateral foot side of the reinforced region A10 in the foot width direction. As shown in FIGS. 5 and 6, the non-overlapping region A20 includes an inner non-overlapping region A21 and an outer non-overlapping region A22.

The inner non-overlapping region A21 is a region formed to be located adjacent to the medial foot side of the reinforced region A10 in the foot width direction. The outer non-overlapping region A22 is a region formed to be located adjacent to the lateral foot side of the reinforced region A10 in the foot width direction. As shown in FIGS. 5 and 6, preferably a length W21 of the inner non-overlapping region A21 and a length W22 of the outer non-overlapping region A22 in the foot width direction are each set to approximately 5% to 15% of the maximum dimension W, in the foot width direction, of the forefoot region R1 or the midfoot region R2 of the midsole body 110. In the present embodiment, the length W21 and the length W22 are each set to 8% of the maximum dimension W.

Any one of the inner non-overlapping region A21 and the outer non-overlapping A22 can be absent. Specifically, the plate 120 may not be located in a central portion of the midsole body 110 in the foot width direction, but can be located to extend from the central portion to one side in the foot width direction of the midsole body 110, so that the inner non-overlapping region A21 or the outer non-overlapping region A22 is not formed.

The non-overlapping region A20 can further include a front non-overlapping region A23. The front non-overlapping region A23 is a region formed frontward of the reinforced region A10 in the foot length direction. In the present embodiment, the non-overlapping region A20 has a shape annularly surrounding the reinforced region A10.

The plate 120 has a rear edge 126 formed at the rear end in the foot length direction. The rear edge 126 has a shape extending gradually frontward in the foot length direction, toward the medial foot side in the foot width direction. The rear edge 126 is formed to be located substantially away from the plantar arches (foot arches) of the sole of the wearer.

Next, the outsole 200 is described. The outsole 200 is connected to the lower surface of the midsole 100 to form a ground contact surface. The outsole 200 is made from rubber or the like. The outsole 200 covers at least a part of the lower surface of the midsole 100. The outsole 200 can cover only a part of the lower surface of the midsole 100 or cover the entire region of the lower surface of the midsole 100.

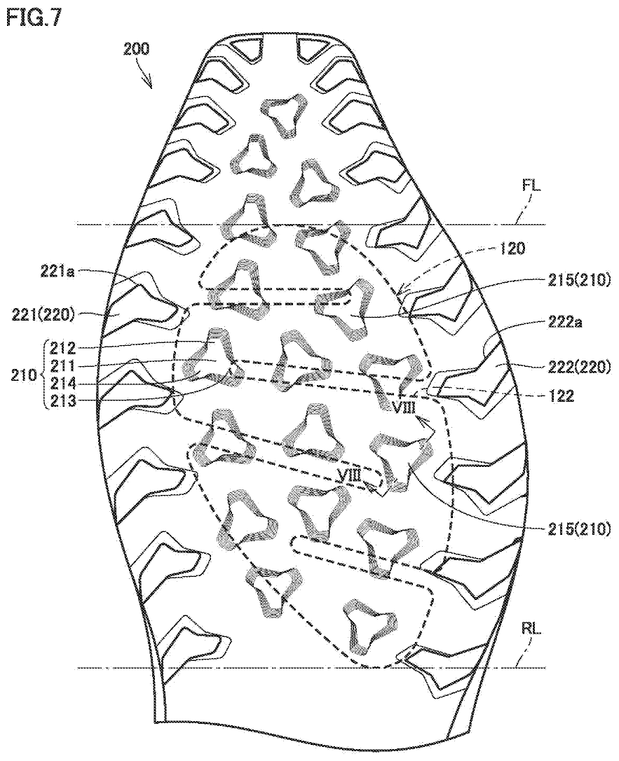

As shown in FIG. 7, the outsole 200 includes a plurality of central protrusions 210 and a plurality of lateral protrusions 220.

A plurality of central protrusions 210 are formed in a region overlapping the reinforced region A10 in the thickness direction. In FIG. 7, the plate 120 is indicated by a broken line. Each central protrusion 210 includes a central portion 211, a first protrusion 212, a second protrusion 213, and a third protrusion 214.

The central portion 211 has a shape extending in the thickness direction.

The first protrusion 212 has a shape protruding from the central portion 211 in the direction orthogonal to the thickness direction.

The second protrusion 213 has a shape extending from the central portion 211 in the direction orthogonal to the thickness direction and crossing the direction in which the first protrusion 212 protrudes from the central portion 211.

The third protrusion 214 has a shape protruding from the central portion in the direction orthogonal to the thickness direction and crossing both the direction in which the first protrusion 212 protrudes from the central portion 211 and the direction in which the second protrusion 213 protrudes from the central portion 211.

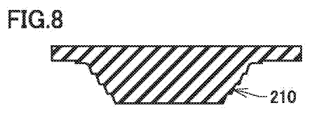

As shown in FIG. 7, each central protrusion 210 has a shape that is turned around the central portion 211 toward the bottom (frontward in the direction orthogonal to the plane of FIG. 7) in the thickness direction. As shown in FIG. 8, each central protrusion 210 has a shape having its outline decreasing gradually toward the bottom (downward in FIG. 8) in the thickness direction. The sum of respective areas of the central protrusions 210 as seen in bottom view is set to 50% or less of the area of the reinforced region A10. Preferably, the central protrusions 210 are arranged to occupy 50% to 20% of the area of the reinforced region A10. The central protrusions 210 are considered as having a shape and functions to follow internal rotation of the foot during running and provide effective gripping in every direction, and to be able to adapt to complicated motion by spaces provided between the protrusions in consideration of the density at which the protrusions are arranged.

A plurality of central protrusions 210 include a group of outer array protrusions 215 arranged at intervals in the foot length direction on the lateral foot side (right side in FIG. 7) in the foot width direction. Each central protrusion 210 included in the group of outer array protrusions 215 has a front surface in the foot length direction that is shaped to project rearward (toward the heel) in the foot length direction.

A plurality of lateral protrusions 220 are formed laterally of a plurality of central protrusions 210 in the foot width direction. Specifically, a plurality of lateral protrusions 220 are formed in a region that overlaps, in the thickness direction, a region between a front end line FL and a rear end line RL, and also overlaps, in the thickness direction, the non-overlapping region A20. As shown in FIG. 7, the front end line FL is a line passing through the front end of the reinforced region A10 in the foot length direction, and extending in parallel with the foot width direction. The rear end line RL is a line passing through the rear end of the reinforced region A10 in the foot length direction, and extending in parallel with the foot width direction. The outline of each central protrusion 210 is smaller than the outline of each lateral protrusion 220.

A plurality of lateral protrusions 220 include a plurality of inner protrusions 221 formed on the medial foot side relative to the plurality of central protrusions 210 in the foot width direction, and a plurality of outer protrusions 222 formed on the lateral foot side relative to the plurality of central protrusions 210 in the foot width direction. A plurality of inner protrusions 221 and a plurality of outer protrusions 222 are arranged at intervals in the foot length direction. A front surface 221a of each inner protrusion 221 in the foot length direction has a shape projecting frontward (toward the toes) in the foot length direction to promote the take-off phase. A front surface 222a of each outer protrusion 222 in the foot length direction has a shape recessed rearward (toward the heel) to exhibit a braking function in the ground contact phase.

Here, a running motion is described. During a running motion, usually an outer part of the shoe 1 in the foot width direction is brought into contact with the ground and an inner part of the shoe 1 in the foot width direction effects the take-off phase, in most cases. In the sole 10 of the present embodiment, the midsole body 110 includes the non-overlapping region A20 formed to be located adjacent to the inner side and the outer side of the reinforced region A10 which overlaps the plate 120 in the thickness direction. In this non-overlapping region A20, the cushioning property or the flexibility of the midsole body 110 is more effective than the reinforcement effect produced by the plate 120, and therefore, restrictions on foot motion in the ground contact phase and the take-off phase are alleviated.

Moreover, the plate 120 effectively reinforces the midsole body 110, and therefore, impact applied to the foot particularly in the ground contact phase is alleviated. In addition, the rear edge 126 of the plate 120 has a shape extending gradually frontward in the foot length direction, toward the medial foot side in the foot width direction, and therefore, the plate 120 is prevented from overlapping the arches of the foot of the wearer in the thickness direction.

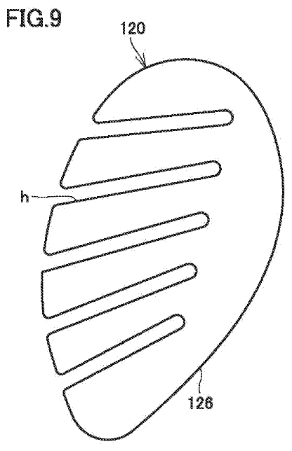

With reference to FIGS. 9 to 13, respective modifications of the plate 120 according to the above-described embodiment are described. FIGS. 9 to 13 each show a bottom view of a plate 120 for the left foot.

### Modification 1

As shown in FIG. 9, all the slits formed in the plate 120 can open on the lateral foot side (right side in FIG. 9) in the foot width direction. This makes the impact alleviating function work in the ground contact phase during running motion.

### Modification 2

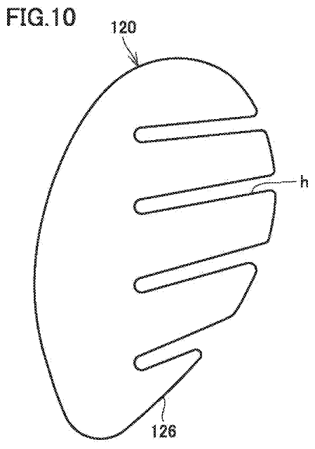

As shown in FIG. 10, all the slits formed in the plate 120 can open on the medial foot side (left side in FIG. 10) in the foot width direction. Thus, take-off motion during the running motion is not hindered.

Modifications 1 and 2 each provide slits each having a shape that is opened on the medial foot side or the lateral foot side in the foot width direction, and can accordingly promote a function of alleviating impact in the ground contact phase and a function of not hindering the take-off motion.

### Modification 3

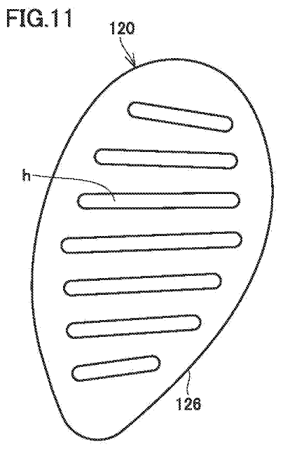

As shown in FIG. 11, all the slits formed in the plate 120 each can have an outer edge formed on the outer side in the foot width direction, and an inner edge formed on the inner side in the foot width direction. Accordingly, the rigidity of the plate 120 is enhanced. Thus, impact applied to the foot in the ground contact phase is alleviated.

### Modification 4

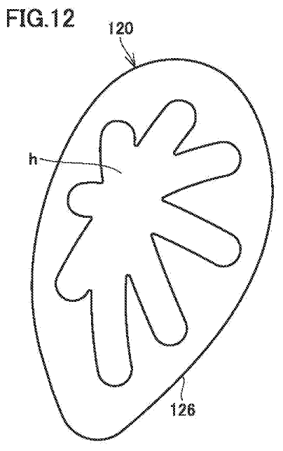

As shown in FIG. 12, a single through hole including the MP portion through hole h can be formed in the plate 120.

In Modifications 3 and 4, unlike the above-described embodiment, no opening toward the outer edge is provided, and the shortest distance from the edge of the through hole (slits) to the outer edge is shorter than that of the slit having the opening. Like the above-described embodiment, the shape of these modifications can also effect the function of alleviating thrust from the ground in situations where balanced propeling and high plate rigidity of the shoe are required.

### Modification 5

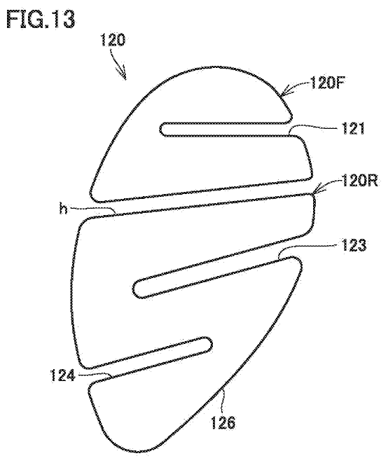

As shown in FIG. 13, the plate 120 can be made up of a front part 120F and a rear part 120R that are separated from each other in the foot length direction, with the MP portion through hole h interposed therebetween. The front part 120F and the rear part 120R can be different from each other, as required, in terms of the rigidity and the width of the through hole.

It would be appreciated by those skilled in the art that the above-described illustrative embodiment is a specific example of the aspects as set forth below.

Aspect 1

A sole forming a part of a shoe, the sole comprising:

a midsole; and

an outsole connected to a lower surface of the midsole and forming a ground contact surface, wherein

the midsole includes:
a midsole body including a forefoot region overlapping, in a thickness direction of the sole, a forefoot portion of a wearer of the shoe, a midfoot region overlapping, in the thickness direction, a midfoot portion of the wearer, and a rearfoot region overlapping, in the thickness direction, a rearfoot portion of the wearer, and
a plate made from a material having a hardness higher than a hardness of the midsole body, and fixed to the midsole body to overlap, in the thickness direction, MP joints of a foot of the wearer and extend on the forefoot region and the midfoot region.
the plate includes:
   an MP portion through hole extending, in the thickness direction, through a region including at least a part of a portion overlapping, in the thickness direction, MP joints of the foot of the wearer, and
   a rear edge formed at a rear end in a foot length direction of the shoe, and having a shape extending gradually frontward in the foot length direction, toward a medial foot side in a foot width direction of the shoe, and
the midsole body includes:
   a reinforced region overlapping the plate in the thickness direction and being reinforced by the plate; and
   a non-overlapping region that is formed to be located adjacent to at least one of a medial foot side and a lateral foot side of the reinforced region in the foot width direction, and does not overlap the plate in the thickness direction.

In this sole, the midsole body includes the non-overlapping region formed to be located adjacent to at least one of the medial foot side and the lateral foot side of the reinforced region which overlaps the plate in the thickness direction. In this non-overlapping region. the cushioning property or the flexibility of the midsole body is more effective than the reinforcement effect produced by the plate, and therefore, restrictions on foot motion in at least one of the ground contact phase and the take-off phase are alleviated. Further, the rear edge can be located away from the foot arches.

Aspect 2

The sole according to Aspect 1, wherein

the non-overlapping region includes:
an inner non-overlapping region formed to be located adjacent to the medial foot side of the reinforced region in the foot width direction; and
an outer non-overlapping region formed to be located adjacent to the lateral foot side of the reinforced region in the foot width direction.

This aspect alleviates restrictions on foot motion in both the ground contact phase and the take-off phase.

Aspect 3

The sole according to Aspect 2, wherein the non-overlapping region further includes a front non-overlapping region formed frontward of the reinforced region in the foot length direction.

This aspect further alleviates restrictions on foot motion in the take-off phase.

Aspect 4

The sole according to any of Aspects 1 to 3, wherein

in an upper surface of the midsole body, at least one groove is formed, and the at least one groove has a shape extending gradually rearward in the foot length direction, from a medial foot side toward a lateral foot side in the foot width direction, and

the at least one groove is formed in a region including at least a part of a portion overlapping, in the thickness direction, the MP joints of the foot of the wearer.

This aspect facilitates flexure of a portion of the midsole in the vicinity of the portion overlapping, in the thickness direction, the MP joints of the foot of the wearer.

Accordingly, restrictions on foot motion, particularly in the take-off phase, are alleviated.

Aspect 5

The sole according to Aspect 4, wherein the at least one groove has a shape curved to project frontward in the foot length direction, as seen in plan view.

This aspect further alleviates restrictions on foot motion in the take-off phase.

Aspect 6

The sole according to Aspect 4 or 5. wherein the at least one groove crosses, in the thickness direction, the MP portion through hole.

This aspect suppresses excessive decrease of the bending rigidity in a portion of the midsole in the vicinity of the portion overlapping the MP joints of the foot of the wearer in the thickness direction, as compared with the case where the MP portion through hole and the groove completely overlap each other in the thickness direction.

Aspect 7

The sole according to any of Aspects 1 to 6, wherein

the outsole includes:
a plurality of central protrusions formed in a region overlapping, in the thickness direction, the reinforced region; and
a plurality of lateral protrusions formed in a region that overlaps, in the thickness direction, a region between a front end line and a rear end line, and overlaps, in the thickness direction, the non-overlapping region, wherein the front end line passes through a front end of the reinforced region in the foot length direction and extends in parallel with the foot width direction, and the rear end line passes through a rear end of the reinforced region in the foot length direction and extends in parallel with the foot width direction, and

an outline of each of the plurality of central protrusions is smaller than an outline of each of the plurality of lateral protrusions.

This aspect increases the gripping force for the ground contact surface while suppressing inhibition of deformation of the region of the outsole overlapping the reinforced region, and inhibition of deformation of the plate.

Aspect 8

The sole according to Aspect 7, wherein

each of the central protrusions includes:
a central portion extending in the thickness direction;
a first protrusion protruding from the central portion in a direction orthogonal to the thickness direction;
a second protrusion protruding from the central portion in a direction orthogonal to the thickness direction and crossing the direction in which the first protrusion protrudes from the central portion; and
a third protrusion protruding from the central portion in a direction orthogonal to the thickness direction and crossing both the direction in which the first protrusion protrudes from the central portion and the direction in which the second protrusion protrudes from the central portion.

This aspect makes the gripping force more effective in every direction.

Aspect 9

The sole according to Aspect 8, wherein each of the central protrusions has a shape turned around the central portion toward a bottom in the thickness direction.

This aspect forms a plurality of faces in the outer circumferential surface of each central protrusion, which thereby further increases the gripping force.

Aspect 10

The sole according to any of Aspects 1 to 9, wherein the MP portion through hole is opened on a lateral foot side in the foot width direction.

This aspect reduces the bending rigidity of the plate in the vicinity of the MP portion through hole, which thereby alleviates restrictions on foot motion.

Aspect 11

The sole according to Aspect 10, wherein the MP portion through hole has an inner edge formed on a medial foot side relative to a shoe center in the foot width direction.

This aspect ensures a sufficient length of the MP portion through hole in the foot width direction, which thereby further alleviates restrictions on foot motion.

Aspect 12

The sole according to Aspect 10 or 11, wherein the MP portion through hole has a shape extending gradually rearward in the foot length direction, toward the lateral foot side in the foot width direction.

This aspects facilitates bending, along the MP joints, of a portion of the plate in the vicinity of the MP portion through hole.

Aspect 13

A shoe comprising:

a sole according to any of Aspects 1 to 12; and

an upper portion connected to the sole and forming, together with the sole, a space for receiving the foot of the wearer.

It should be construed that embodiments disclosed herein are given by way of illustration in all respects, not by way of limitation. It is intended that the scope of the present invention is defined by claims, not by the description above. and encompasses all modifications and variations equivalent in meaning and scope to the claims.

1. A sole forming a part of a shoe, the sole comprising:
a midsole; and
an outsole connected to a lower surface of the midsole and forming a ground contact surface,
the midsole including
a midsole body including a forefoot region configured to overlap, in a thickness direction of the sole, a forefoot portion of a wearer of the shoe, a midfoot region configured to overlap, in the thickness direction, a midfoot portion of the wearer, and a rearfoot region configured to overlap, in the thickness direction, a rearfoot portion of the wearer, and
a plate formed from a material having a hardness higher than a hardness of the midsole body, and fixed to the midsole body to overlap, in the thickness direction, MP joints of a foot of the wearer and extend on the forefoot region and the midfoot region,
the plate including
an MP portion through hole extending, in the thickness direction, through a region including at least a part of a portion configured to overlap, in the thickness direction, MP joints of the foot of the wearer, and
a rear edge formed at a rear end in a foot length direction of the shoe, and having a shape extending gradually frontward in the foot length direction, toward a medial foot side in a foot width direction of the shoe, and
the midsole body including
a reinforced region overlapping the plate in the thickness direction and being reinforced by the plate, and
a non-overlapping region that is formed to be located adjacent to at least one of a medial foot side and a lateral foot side of the reinforced region in the foot width direction, and does not overlap the plate in the thickness direction.

2. The sole according to claim 1, wherein
the non-overlapping region includes
an inner non-overlapping region located adjacent to the medial foot side of the reinforced region in the foot width direction; and
an outer non-overlapping region located adjacent to the lateral foot side of the reinforced region in the foot width direction.

3. The sole according to claim 2, wherein the non-overlapping region further includes a front non-overlapping region frontward of the reinforced region in the foot length direction.

4. The sole according to claim 1, wherein
in an upper surface of the midsole body, at least one groove is disposed, and the at least one groove has a shape extending gradually rearward in the foot length direction, from a medial foot side toward a lateral foot side in the foot width direction, and
the at least one groove is disposed in a region including at least a part of a portion configured to overlap, in the thickness direction, the M P joints of the foot of the wearer.

5. The sole according to claim 4, wherein the at least one groove has a shape curved to project frontward in the foot length direction, as seen in a plan view.

6. The sole according to claim 4, wherein the at least one groove crosses, in the thickness direction, the MP portion through hole.

7. The sole according to claim 1, wherein
the outsole includes:
a plurality of central protrusions formed in a region configured to overlap, in the thickness direction, the reinforced region; and
a plurality of lateral protrusions in a region that overlaps, in the thickness direction, a region between a front end line and a rear end line, and overlaps, in the thickness direction, the non-overlapping region, the front end line passes through a front end of the reinforced region in the foot length direction and extends in parallel with the foot width direction, and the rear end line passes through a rear end of the reinforced region in the foot length direction and extends in parallel with the foot width direction, and
an outline of each of the plurality of central protrusions is smaller than an outline of each of the plurality of lateral protrusions.

8. The sole according to claim 7, wherein
each of the central protrusions includes
a central portion extending in the thickness direction;
a first protrusion protruding from the central portion in a direction orthogonal to the thickness direction;
a second protrusion protruding from the central portion in a direction orthogonal to the thickness direction and crossing the direction in which the first protrusion protrudes from the central portion; and
a third protrusion protruding from the central portion in a direction orthogonal to the thickness direction and crossing both the direction in which the first protrusion protrudes from the central portion and the direction in which the second protrusion protrudes from the central portion.

9. The sole according to claim 8, wherein each of the central protrusions has a shape turned around the central portion toward a bottom in the thickness direction.

10. The sole according to claim 1, wherein the MP portion through hole is opened on a lateral foot side in the foot width direction.

11. The sole according to claim 10, wherein the M P portion through hole has an inner edge formed on a medial foot side relative to a shoe center in the foot width direction.

12. The sole according to claim 10, wherein the MP portion through hole has a shape extending gradually rearward in the foot length direction, toward the lateral foot side in the foot width direction.

13. A shoe comprising:
a sole according to claim 1; and
an upper portion connected to the sole and forming, together with the sole, a space for receiving the foot of the wearer.
